(19) United States
(12) Patent Application Publication
(10) Pub. No.: US 2014/0019902 A1
(43) Pub. Date: Jan. 16, 2014

(54) PROGRESS BARS FOR MEDIA CONTENT

(71) Applicants: Lisa Seacat DeLuca, San Francisco, CA (US); Dana L. Price, Cary, NC (US)

(72) Inventors: Lisa Seacat DeLuca, San Francisco, CA (US); Dana L. Price, Cary, NC (US)

(73) Assignee: International Business Machines Corporation, Armonk, NY (US)

(21) Appl. No.: 13/547,704

(22) Filed: Jul. 12, 2012

(51) Int. Cl. G06F 3/048

(52) U.S. Cl. 715/772

(57) ABSTRACT

Some example embodiments include a method for presenting media content. The method includes decoding the media content having a number of time segments to access metadata that defines a number of selectable characteristics for semantic content in the media content. The method includes presenting to a viewer of media content the number of selectable characteristics for the semantic content. The method includes receiving, from the viewer, a selectable characteristic of the number of selectable characteristics. The method includes presenting, along with the media content, a progress bar for the media content that defines, through the number of time segments, temporal positions in the media content where the selectable characteristic is within the media content. The presenting of the progress bar includes presenting a graphic in the progress bar that is different for different values for a same selectable characteristic of the at least one selectable characteristic.

### BACKGROUND

Embodiments of the inventive subject matter generally relate to the field of computers, and, more particularly, to progress bars for media content.

There are an increasing number of choices and availability of different media content for viewing, listening, etc. Examples of different media content include video, audio, social media timelines, etc. Because of the amount of media content available, many viewers may only want to view parts or segments of the media content that are relevant or interesting to them. Conventionally, there are progress bars that can be presented to viewers along with the media content to enable the viewer to identify what they are viewing in time relative to the entire media content.

### SUMMARY

Some example embodiments include a method for presenting media content. The method includes decoding the media content having a number of time segments to access metadata that defines a number of selectable characteristics for semantic content in the media content. The method includes presenting to a viewer of media content the number of selectable characteristics for the semantic content. The method includes receiving, from the viewer, a selectable characteristic of the number of selectable characteristics. The method includes presenting, along with the media content, a progress bar for the media content that defines, through the number of time segments, temporal positions in the media content where the selectable characteristic is within the media content. The presenting of the progress bar includes presenting a graphic in the progress bar that is different for different values for a same selectable characteristic of the at least one selectable characteristic.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a Graphical User Interface (GUI) for viewer-selectable progress bars for media content based on different semantic content in the media content, according to some example embodiments.

FIG. 2 depicts additional example progress bars that are selectable for viewing along with media content, according to some example embodiments.

FIG. 3 depicts a flowchart for providing viewer-selectable progress bars for media content based on different semantic content in the media content, according to some example embodiments.

FIG. 4 depicts a computer system, according to some example embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

Some example embodiments provide one or more progress bars to be displayed along with associated media content (e.g., video, audio, social media timeline, etc.), wherein the progress bars are associated with semantic content within the media content. Examples of semantic content for the progress bars include specific characters, gender of the characters, scenery, geographic locations, chapters, calendar days, commercials, etc. Another example of semantic content includes content that warrants a higher rating for a movie. For example, for an R-rated movie, the progress bar identifies those parts of the movie that contain adult material, adult themes, intense violence, etc. The progress bars can include different colors, graphics, etc. for differentiating on the different values for the semantic content. To illustrate, the progress bar can have pink for time segments when a woman is being shown in the video, blue for time segments when a man is being shown in the video, and both pink and blue for time segments when a woman and a man is being shown in the video. Some example embodiments can have a single progress bar to display data for multiple types of semantic content. For example, a single progress bar can differentiate among different geographic locations and characters.

To further illustrate, for a progress bar that identifies characters in the media content, the presence of each character can be represented visually with different colors, graphics, etc. in the progress bar relative to where they appear in the media content. Also, groups of characters in such a progress bar can be presented by multiple colors, graphics, etc. Additionally for such progress bars, the colors, graphics, etc. can be different for a same character appearing depending on the frequency of their talking during the time segment or any other type of active involvement. For example, if a character is actively involved in a scene, the associated time segment in the progress bar would be a bright, strong variant of a color. However, if the same character is in a scene but not actively involved, the associated time segment in the progress bar would a muted, light variant of the same color.

For a progress bar that identifies commercials, the graphics for the time segments in the progress bar having the commercials can include a symbol of the product, company, etc. For a progress bar that identifies temporal information regarding the media content (e.g., calendar days, seasons of the year, etc. in a movie), the temporal information can be represented visually with different colors, graphics, etc. in the progress bar relative to where the temporal information appearing in the media content.

In some example embodiments, the information needed to produce these progress bars can be defined in metadata that is encoded in the media content. Some example embodiments would decode metadata that is encoded in the media content. Therefore, the encoded metadata could include the data necessary to provide the progress bars according to the semantic content in the media content. For example, metadata can identify the segments in the media content when geographic locations are being displayed, characters are in a scene, etc. Additionally, some example embodiments enable a user (e.g., a viewer) to customize the progress bars that are provided along with the media content. For example, a user can select one to N number of progress bars for presenting along with the media content. In some example embodiments, a user can customize the media content to create their own tagging of the media content. For example, a first user can select starting and end points of time segments in the media content that the user finds of value, finds interesting, that is of a certain type, etc. These selections by the first user could be used to define time segments in a progress bar that is customized by the first user. A second user can then select this progress bar as part of the viewing of the media content. Accordingly, the first user can provide a progress bar that can be used by other users. Therefore, as described, the users can select the number and types of progress bars as well as create their own customized progress bars that are accessible by others.

In some example embodiments, the media content can include social media timelines. For example, there can be progress bars that define when certain person(s) are being shown in pictures or videos, written about, etc. in a given social media timeline. To illustrate, a progress bar can define when the immediate family is within a person's social media timeline. Other progress bars for social media timelines can include geographic locations shown or described in the timeline, times of years (Christmas, all holidays, etc.), etc. Such progress bars allows viewers of a person's social media timeline to view those parts of the timeline they are most interested in very efficiently. This is in comparison to requiring the viewer to wade through a vast amount of uninteresting information (e.g., unknown persons, unknown events, etc.) in a person's social media timeline.

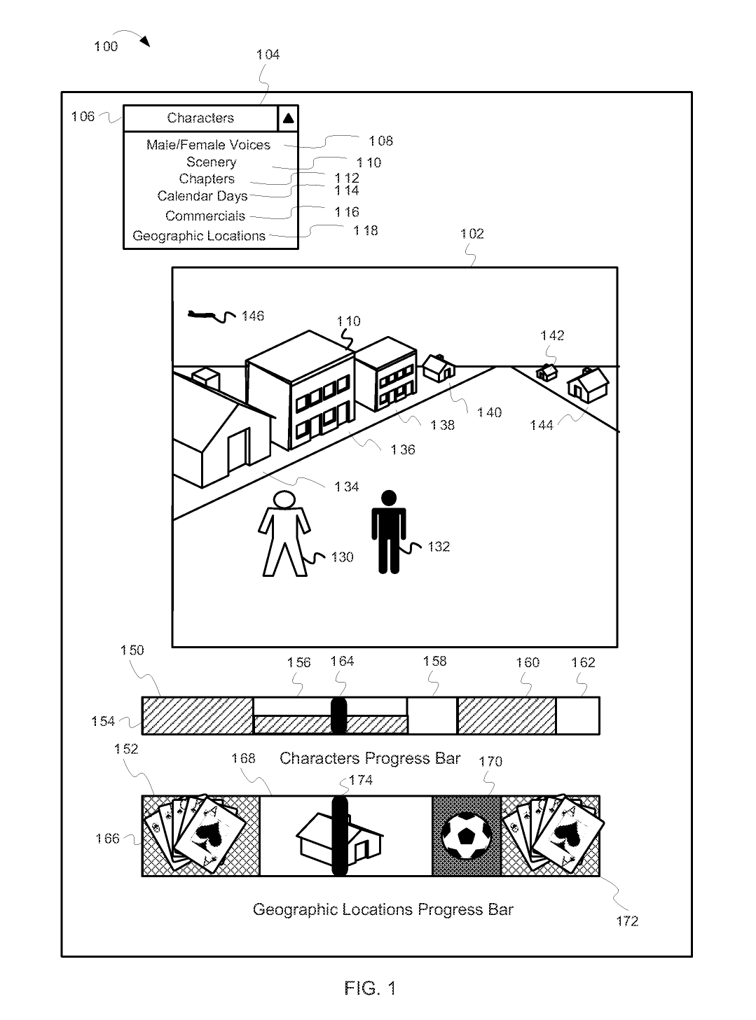

FIG. 1 depicts a Graphical User Interface (GUI) for viewer-selectable progress bars for media content based on different semantic content in the media content, according to some example embodiments. In particular, FIG. 1 depicts a GUI 100 that includes a display 102 of media content (video for this example). The GUI 100 includes a selectable list 104 of semantic content for displaying different progress bars. The GUI 100 also includes two progress bars (a progress bar 150 and a progress bar 152). The progress bar 150 is a progress bar having time segments for when certain characters are shown in the video in the display 102. The progress bar 152 is a progress bar having time segments of when certain geographic locations are shown in the video in the display 102.

The video in the display 102 includes two characters (a person 130 and a person 132). The video also includes a number of buildings (buildings 134-144) and an airplane 146. The selectable list 104 allows a viewer of the video to select one or more of the selectable characteristics for the semantic content of the video. In this example, the selectable characteristics include characters 106, male/female voices 108, scenery 110, chapters 112, calendar days 114, commercials 116, and geographic locations 118. The selectable list 104 can include any number of other selectable characteristics for the semantic content (see description of other examples above).

In this example, the viewer of the video selected a progress bar for characters in the video (the progress bar 150) and a progress bar for geographic locations in the video (the progress bar 152). The progress bar 150 includes a number of time segments (time segments 154, 156, 158, 160, and 162) and a marker 164 to mark what part of the video is currently being displayed. In this example, there are two characters being tracked for the progress bar 150. A first character is represented by striped time segments, and a second character is represented by non-striped time segments. Accordingly, the first character is present in the video in the time segment 154, the time segment 156, and the time segment 160. The second character is present in the video in the time segment 156, the time segment 158, and the time segment 162. As shown, if both characters are present in a same time segment (e.g., the time segment 156), both characters are represented in the progress bar 150 for that time segment.

The progress bar 152 includes a number of time segments (time segments 166, 168, 170, and 172) and a marker 174 to mark what part of the video is currently being displayed. In this example, there are three different geographical locations being tracked for the progress bar 152. A first geographic location is represented by playing cards on a first background (see the time segment 166 and the time segment 172). For example, the first geographic location can represent Las Vegas, a specific casino, etc. A second geographic location is represented by a house on a second background (see time segment 168). For example, the second geographic location can represent a city, town, neighborhood, etc. A third geographic location is represented by a soccer ball on a third background (see time segment 170). For example, the third geographic location can represent a soccer field, a soccer sporting event, etc.

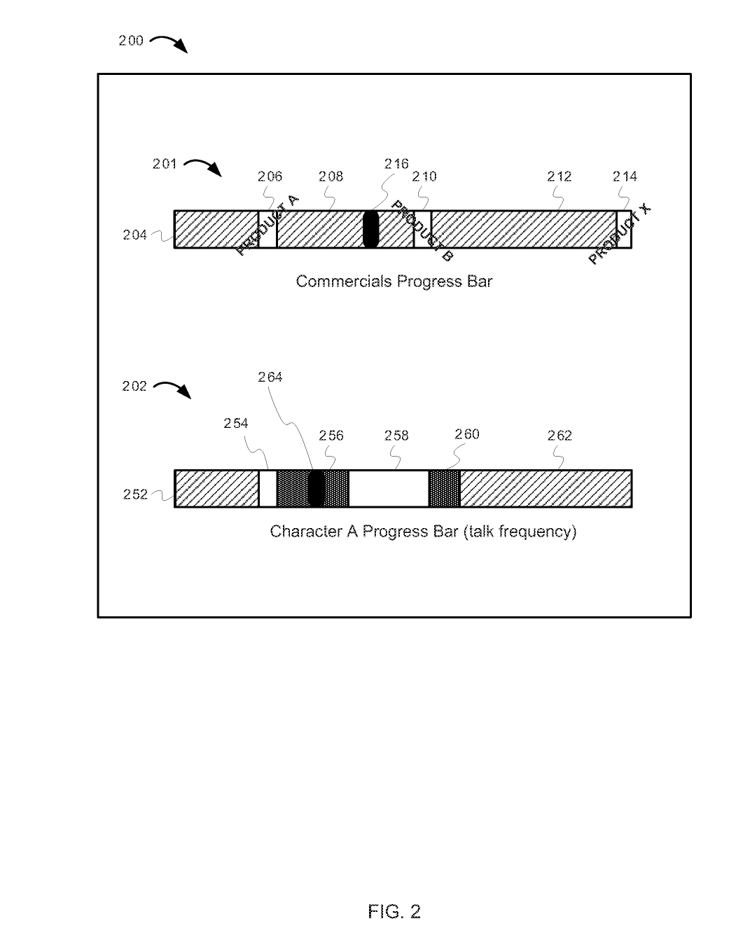

FIG. 2 depicts additional example progress bars that are selectable for viewing along with media content, according to some example embodiments. FIG. 2 depicts a GUI 200 that includes two additional progress bars (a progress bar 201 and a progress bar 202). The progress bar 201 includes time segments for commercials in the media content. The progress bar 202 includes time segments for a character (Character A) based on their active participation (e.g., their talk frequency).

The progress bar 201 includes a number of time segments (time segments 204, 206, 208, 210, 212, and 214) and a marker 216 to mark what part of the media content is currently being displayed. In this example, there are three different commercials in three different time segments. The time segment 204 is a non-commercial time segment. The time segment 206 includes a commercial for Product A. As shown, a graphic, icon, etc. representing Product A is displayed over the time segment 206. The time segment 208 is another non-commercial time segment. The time segment 210 includes a commercial for Product B. As shown, a graphic, icon, etc. representing Product B is displayed over the time segment 210. The time segment 212 is another non-commercial time segment. The time segment 214 includes a commercial for Product X. As shown, a graphic, icon, etc. representing Product X is displayed over the time segment 214.

The progress bar 202 includes a number of time segments (time segments 252, 254, 256, 258, 260, and 262) and a marker 264 to mark what part of the media content is currently being displayed. In this example, the progress bar 202 identifies when Character A is in the media content being displayed. Also, two different graphics are presented in the progress bar 202 for Character A. A first graphic comprises diagonal lines that represents when Character A is below a threshold of talk frequency (or other active participation) in the given time segment. For example, if Character A's active participation in the time segment is less than 25%, the first graphic is used. The first graphic is used in the time segment 252 and the time segment 262. A second graphic comprises a heavily dotted pattern that represents when Character A is above the threshold of talk frequency (or other active participation) in the given time segment. The second graphic is used in the time segment 256 and the time segment 260. Character A is not in the time segment 254 and the time segment 258. These varying levels for a same characteristic are applicable to any other semantic content in the media content. For example, different graphics can represent varying levels of violence, adult themes, etc.

As described above, the media content can include social media timelines. For example, there can be progress bars that define when certain person(s) are being shown in pictures or videos, written about, etc. in a given social media timeline (immediate family, times of year, etc.). Also as described above, some example embodiments allow a viewer or user to define their own progress bar. These progress bars can be for any type of media content (including social media timelines). Accordingly, a user can provide a progress bar that can be used by other users.

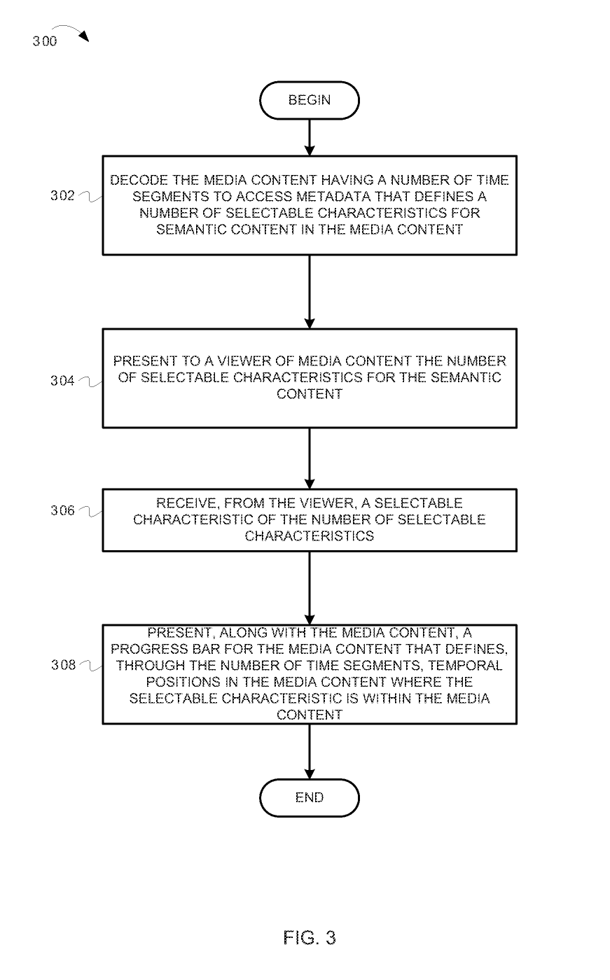

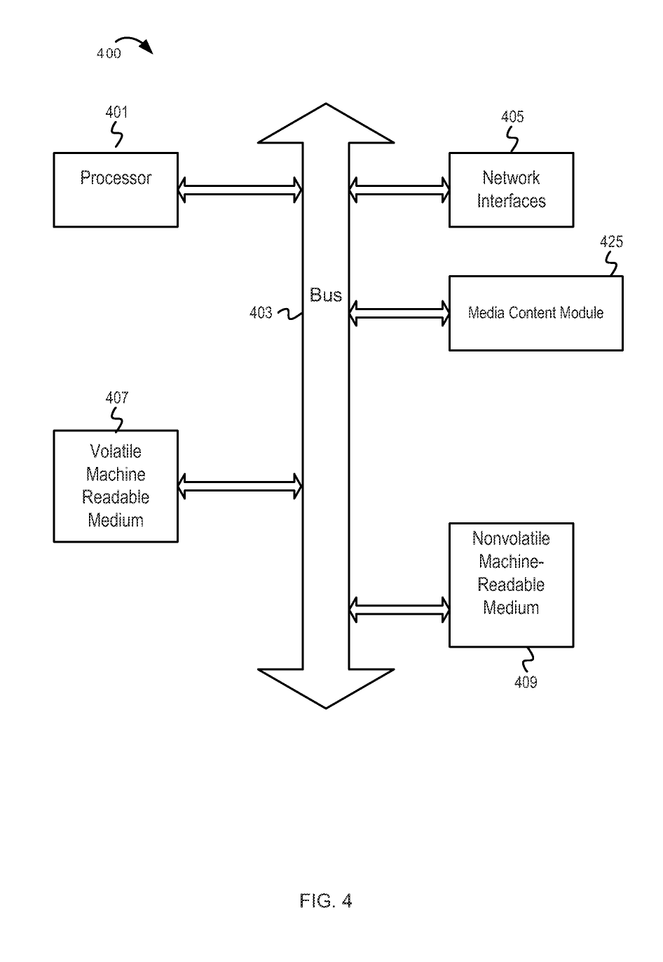

FIG. 3 depicts a flowchart for providing viewer-selectable progress bars for media content based on different semantic content in the media content, according to some example embodiments. FIG. 3 depicts a flowchart 300. Operations of the flowchart 300 are described in reference to FIGS. 1-2. In this description, the operations are described as being performed by a media content module 425 of FIG. 4, which is described in more detail below. In particular, the media content module 425 can be software executing on a processor for performing the operations described. The operations of the flowchart 300 begin at block 302.

At block 302, the media content module decodes the media content having a number of time segments to access metadata that defines a number of selectable characteristics for semantic content in the media content. The encoded metadata could include the data necessary to provide the progress bars according to the semantic content in the media content. For example, metadata can identify the segments in the media content when geographic locations are being displayed, characters are in a scene, etc. Operations of the flowchart 300 continue at block 304.

At block 304, the media content module presents to a viewer of media content the number of selectable characteristics for the semantic content. In particular, the media content module can present the number of selectable characteristics for the semantic content. With reference to FIG. 1, the media content module presents the selectable list 104 to allow a viewer of the video to select one or more of the selectable characteristics for the semantic content of the video. In this example, the selectable characteristics include characters 106, male/female voices 108, scenery 110, chapters 112, calendar days 114, commercials 116, and geographic locations 118. The selectable list 104 can include any number of other selectable characteristics for the semantic content (see description of examples above). Also in some example embodiments, a user can customize the media content to create their own tagging of the media content. For example, a first user can select starting and end points of time segments in the media content that the user founds of value, interesting, of a certain type, etc. These selections by the first user could be used to define time segments in a progress bar that is customized by the first user. In other words, a progress bar is presented that is customized by the first user. A second user can then select this progress bar as part of the viewing of the media content. Accordingly, the first user can provide a progress bar that can be used by other users. Therefore, as described, the users can select the number and types of progress bars as well as create their own customized progress bars that are accessible by others. Operations of the flowchart 300 continue at block 306.

At block 306, the media content module receives, from the viewer, a selectable characteristic of the number of selectable characteristics. With reference to the example of FIG. 1, the viewer of the video selected a progress bar for characters in the video (the progress bar 150) and a progress bar for geographic locations in the video (the progress bar 152). Operations of the flowchart 300 continue at block 308.

At block 308, the media content module presents, along with the media content, a progress bar for the media content that defines, through the number of time segments, temporal positions in the media content where the selectable characteristic is within the media content. With reference to the example of FIG. 1, the media content module presents the progress bar 150 and the progress bar 152 along with the video in the display 102. While described relative to a video, in some example embodiments, the media content can include social media timelines. For example, there can be progress bars that define when certain person(s) are being shown in pictures or videos, written about, etc. in a given social media timeline. To illustrate, a progress bar can define when the immediate family is within a person's social media timeline. Other progress bars for social media timelines can include geographic locations shown or described in the timeline, times of years (Christmas, all holidays, etc.). Such progress bars allows viewers of a person's social media timeline to view those parts of the timeline they are most interested in very efficiently. This is in comparison to requiring the viewer to wade through a vast amount of uninteresting information (e.g., unknown persons) in a person's social media timeline. Operations of the flowchart 300 are complete.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 4 depicts a computer system, according to some example embodiments. A computer system 400 includes a processor 401 (possibly including multiple processors, multiple cores, multiple nodes, and/or implementing multi-threading, etc.). The computer system includes volatile machine-readable medium 407. The volatile machine-readable medium 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a nonvolatile machine-readable medium 409 (e.g., optical storage, magnetic storage, etc.).

The computer system 400 includes a media content module 425 that can perform the operations (as described herein). Any one of these functionalities may be partially (or entirely) implemented in hardware and/or on the processor 401. For example, the functionality may be implemented with an application specific integrated circuit, in logic implemented in the processor 401, in a co-processor on a peripheral device or card, etc.

Further, realizations may include fewer or additional components not illustrated in FIG. 4 (e.g., video cards, audio cards, additional network interfaces, peripheral devices, etc.). The processor 401, the nonvolatile machine-readable medium 409, and the network interface 405 are coupled to the bus 403. Although illustrated as being coupled to the bus 403, the memory 407 may be coupled to the processor 401.

While the embodiments are described with reference to various implementations and exploitations, it will be understood that these embodiments are illustrative and that the scope of the inventive subject matter is not limited to them. In general, techniques for viewer-selectable progress bars for media content based on different semantic content in the media content as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for presenting media content, the method comprising:
decoding the media content having a number of time segments to access metadata that defines a number of selectable characteristics for semantic content in the media content;
presenting to a viewer of media content the number of selectable characteristics for the semantic content;
receiving, from the viewer, a selectable characteristic of the number of selectable characteristics; and
presenting, along with the media content, a progress bar for the media content that defines, through the number of time segments, temporal positions in the media content where the selectable characteristic is within the media content,
wherein the presenting of the progress bar comprises presenting a graphic in the progress bar that is different for different values for a same selectable characteristic of the at least one selectable characteristic.

2. The method of claim 1, wherein the presenting of the graphic comprises:
presenting a first variation of a first graphic for the same selectable characteristic in a first time segment of the progress bar based on a first frequency of the same selectable characteristic in the media content during the first time segment; and
presenting a second variation of the first graphic for the same selectable characteristic in a second time segment in the progress bar based on a second frequency of the same characteristic in the media content during the second time segment, wherein the first frequency is different from the second frequency.

3. The method of claim 2, wherein the first variation of the first graphic comprises a first amount of time that a person being presented in the media content plays an active role that comprises at least speaking, wherein the second variation of the second graphic comprises a second amount of time that the person being presented in the media content plays the active role.

4. The method of claim 1, wherein the media content comprises media content for social networking, wherein the progress bar comprises a timeline of a person's life being presented as part of the social networking.

5. The method of claim 1, further comprising:
receiving, from a different viewer of the media content, a starting point and an ending point in the media that defines at least one of the number of time segments;
wherein the number of selectable characteristics for the semantic content comprises preference viewing defined by the different viewer.

6. The method of claim 1, further comprising:
receiving, from the viewer, a different selectable characteristic of the number of selectable characteristics; and
presenting, along with the media content, a different progress bar for the media content that defines, through the number of time segments, temporal positions in the media content where the different selectable characteristic is within the media content.

7. The method of claim 1, wherein the media content comprise video, wherein the selectable characteristic comprises commercials, wherein the presenting, along with the media content, the progress bar for the media content comprises a graphic that represents a product for a commercial being advertised in the number of time segments.

8. A computer program product for presenting media content, the computer program product comprising:
a computer readable storage medium having computer usable program code embodied therewith, the computer usable program code comprising a computer usable program code configured to:
decode the media content having a number of time segments to access metadata that defines a number of selectable characteristics for semantic content in the media content;
present to a viewer of media content the number of selectable characteristics for the semantic content;
receive, from the viewer, a selectable characteristic of the number of selectable characteristics; and
present, along with the media content, a progress bar for the media content that defines, through the number of time segments, temporal positions in the media content where the selectable characteristic is within the media content,
wherein the computer usable program code configured to present the progress bar comprises computer usable program code configured to presenting a graphic in the progress bar that is different for different values for a same selectable characteristic of the at least one selectable characteristic.

9. The computer program product of claim 8, wherein the computer usable program code configured to present the graphic comprises computer usable program code configured to:
present a first variation of a first graphic for the same selectable characteristic in a first time segment of the progress bar based on a first frequency of the same selectable characteristic in the media content during the first time segment; and
present a second variation of the first graphic for the same selectable characteristic in a second time segment in the progress bar based on a second frequency of the same characteristic in the media content during the second time segment, wherein the first frequency is different from the second frequency.

10. The computer program product of claim 9, wherein the first variation of the first graphic comprises a first amount of time that a person being presented in the media content plays an active role that comprises at least speaking, wherein the second variation of the second graphic comprises a second amount of time that the person being presented in the media content plays the active role.

11. The computer program product of claim 8, wherein the media content comprises media content for social networking, wherein the progress bar comprises a timeline of a person's life being presented as part of the social networking.

12. The computer program product of claim 8, wherein the computer usable program code is configured to:
receive, from a different viewer of the media content, a starting point and an ending point in the media that defines at least one of the number of time segments;
wherein the number of selectable characteristics for the semantic content comprises preference viewing defined by the different viewer.

13. The computer program product of claim 8, wherein the computer usable program code is configured to:
receive, from the viewer, a different selectable characteristic of the number of selectable characteristics; and
present, along with the media content, a different progress bar for the media content that defines, through the number of time segments, temporal positions in the media content where the different selectable characteristic is within the media content.

14. The computer program product of claim 8, wherein the media content comprise video, wherein the selectable characteristic comprises commercials, wherein the computer usable program code configured to present, along with the media content, the progress bar for the media content comprises computer usable program code configured to present a graphic that represents a product for a commercial being advertised in the number of time segments.

15. An apparatus comprising:
a processor; and
a media content module executable on the processor, the media content module configured to,
decode the media content having a number of time segments to access metadata that defines a number of selectable characteristics for semantic content in the media content;
present to a viewer of media content the number of selectable characteristics for the semantic content;
receive, from the viewer, a selectable characteristic of the number of selectable characteristics; and
present, along with the media content, a progress bar for the media content that defines, through the number of time segments, temporal positions in the media content where the selectable characteristic is within the media content,
wherein the presentation of the progress bar comprises an operation to present a graphic in the progress bar that is different for different values for a same selectable characteristic of the at least one selectable characteristic.

16. The apparatus of claim 15, wherein the presentation of the graphic comprises operations configured to:
present a first variation of a first graphic for the same selectable characteristic in a first time segment of the progress bar based on a first frequency of the same selectable characteristic in the media content during the first time segment; and
present a second variation of the first graphic for the same selectable characteristic in a second time segment in the progress bar based on a second frequency of the same characteristic in the media content during the second time segment, wherein the first frequency is different from the second frequency.

17. The apparatus of claim 16, wherein the first variation of the first graphic comprises a first amount of time that a person being presented in the media content plays an active role that comprises at least speaking, wherein the second variation of the second graphic comprises a second amount of time that the person being presented in the media content plays the active role.

18. The apparatus of claim 15, wherein the media content comprises media content for social networking, wherein the progress bar comprises a timeline of a person's life being presented as part of the social networking.

19. The apparatus of claim 15, wherein the media content module is configured to:
receive, from a different viewer of the media content, a starting point and an ending point in the media that defines at least one of the number of time segments;
wherein the number of selectable characteristics for the semantic content comprises preference viewing defined by the different viewer.

20. The apparatus of claim 15, wherein the media content module is configured to:
receive, from the viewer, a different selectable characteristic of the number of selectable characteristics; and
present, along with the media content, a different progress bar for the media content that defines, through the number of time segments, temporal positions in the media content where the different selectable characteristic is within the media content.
